(19) United States
(12) Patent Application Publication
(10) Pub. No.: US 2021/0231775 A1
(43) Pub. Date: Jul. 29, 2021

(54) SYSTEM AND METHOD FOR SMART DEVICE CONTROL USING RADAR

(71) Applicant: Plato Systems, Inc., San Carlos, CA (US)

(72) Inventors: Aria Pezeshk, San Carlos, CA (US); Mashhour Solh, San Carlos, CA (US); Mohammad Amin Arbabian, San Francisco, CA (US)

(21) Appl. No.: 16/773,116

(22) Filed: Jan. 27, 2020

(51) Int. Cl. G01S 7/41; H04L 12/28; G01S 13/86; G01S 7/285; G01S 7/35

(52) U.S. Cl. CPC G01S 7/415; H04L 12/2823; G01S 7/417; G01S 2007/356; G01S 7/285; G01S 7/352; H04L 2012/2849; G01S 13/867

(57) ABSTRACT

Systems and methods for smart device control using radar are disclosed. According to some aspects, a machine receives, using a millimeter-wave multiple antenna array, a radar signal. The machine preprocesses the radar signal to generate radar metadata. The machine determines, using a trained machine learning engine and based on at least the radar metadata, a moving entity and a movement type. The machine identifies, based on at least the determined moving entity and the determined movement type, a smart device and an action for the smart device to take in response to the movement type by the moving entity. The machine transmits, to the smart device, a control signal for the identified action.

### TECHNICAL FIELD

Embodiments pertain to radar processing systems and methods. Some embodiments relate to system(s) and method(s) for smart device control using radar.

### BACKGROUND

During the last decade more and more smart devices—devices capable of communicating via wired or wireless protocol(s)—have been installed in various homes, offices, public places, and the like. This trend is expected to continue into the near future. Efficient techniques for controlling smart device(s) may be desirable.

### BRIEF DESCRIPTION OF THE DRAWINGS

FIG. 1 illustrates the training and use of a machine-learning program, in accordance with some embodiments.

FIG. 2 illustrates an example neural network, in accordance with some embodiments.

FIG. 3 illustrates the training of an image recognition machine learning program, in accordance with some embodiments.

FIG. 4 illustrates the feature-extraction process and classifier training, in accordance with some embodiments.

FIG. 5 is a block diagram of a computing machine, in accordance with some embodiments.

FIG. 6 is a block diagram of a system in which smart device control using radar may be implemented, in accordance with some embodiments.

FIG. 7 is a flow chart of a method for smart device control using radar, in accordance with some embodiments.

FIG. 8 is a flow chart of a method for radar-based classification for person or animal detection and counting, in accordance with some embodiments.

FIG. 9 is a flow chart of a method for radar-based classification for person or animal identification or gesture recognition, in accordance with some embodiments.

FIG. 10 is a flow chart of a method for radar-based person identification that activates or deactivates a speech recognition or vision classification machine, in accordance with some embodiments.

FIG. 11 is a flow chart of a method for radar and camera-based person identification, in accordance with some embodiments.

FIG. 12 is a data flow diagram for classification of a single-frame range doppler angle silhouette (RDAS) using a deep convolutional neural network (CNN), in accordance with some embodiments.

FIG. 13 data flow diagram for classification of sequence of RDASs using a convolutional neural network-recurrent neural network (CNN-RNN) combination, in accordance with some embodiments.

FIG. 14 is a flow chart of a first method for combining radar and camera data, in accordance with some embodiments.

FIG. 15 is a flow chart of a second method for combining radar and camera data, in accordance with some embodiments.

### SUMMARY

The present disclosure generally relates to machines configured to process radar data, including computerized variants of such special-purpose machines and improvements to such variants, and to the technologies by which such special-purpose machines become improved compared to other special-purpose machines that provide technology for processing radar data. In particular, the present disclosure addresses systems and methods for smart device control using radar.

According to some aspects of the technology described herein, a system includes processing circuitry and memory. The processing circuitry receives, using a millimeter-wave multiple antenna array, a radar signal. The processing circuitry preprocesses the radar signal to generate radar metadata. The processing circuitry determines, using a trained machine learning engine and based on at least the radar metadata, a moving entity and a movement type. The processing circuitry identifies, based on at least the determined moving entity and the determined movement type, a smart device and an action for the smart device to take in response to the movement type by the moving entity. The processing circuitry communicates, to the smart device, a control signal for the identified action.

Other aspects include a method to perform the operations of the processing circuitry above, and a machine-readable medium storing instructions for the processing circuitry to perform the above operations.

### DETAILED DESCRIPTION

The following description and the drawings sufficiently illustrate specific embodiments to enable those skilled in the art to practice them. Other embodiments may incorporate structural, logical, electrical, process, and other changes. Portions and features of some embodiments may be included in, or substituted for, those of other embodiments. Embodiments set forth in the claims encompass all available equivalents of those claims.

As discussed above, during the last decade more and more smart devices have been installed in various homes, offices, public places, and the like. This trend is expected to continue into the near future. It may be desirable to control these smart devices using techniques that improve the overall efficiency of the system (e.g. in terms of power consumption), allow for increased privacy, improve the speed and/or accuracy, or otherwise improve the user experience. Some aspects of the technology described herein are directed to smart device control using radar.

As used herein, the term “smart device” encompasses its plain and ordinary meaning. A smart device may include any devices capable of communicating via wired or wireless protocol(s). A smart device may include, among other things, processing circuitry, memory, and communication radio(s) (or wired communication interface(s)) for communicating with control device(s). A smart device may include one or more of: a smart light switch/lamp, a smart microwave, a smart oven, a smart tea or coffee maker, a smart television, a smart audio player, a smart microphone, a smart camera or monitoring device, a smart door, a smart lock, and a smart alarm.

According to some aspects, a control device (e.g., a computing machine) receives, using a millimeter-wave multiple antenna array, a radar signal. The control device may be installed in an environment, for example, in a home, office space or other industrial setting, and may be responsible for controlling multiple smart devices in the environment. The radar signal may include one or more chirps, pulses or orthogonal frequency-division multiplexing (OFDM) signals. The control device preprocesses the radar signal to generate radar metadata. The preprocessing may include computing a range, a velocity, or an angle of the moving entity using a fast Fourier transform (FFT). The control device determines, using a trained machine learning engine and based on at least the radar metadata, a moving entity and a movement type. The moving entity may include one or more of a specific person, a non-specific person, an animal, a moving object, a group of moving persons, animals or objects. For example, the moving entity may be a specific entity (e.g., John Q. Sample) or a more generalized entity (e.g., any member of the Sample family, any human, the Sample family dog, etc.) and the movement type may be a specific movement (e.g., sitting down on the living room couch and waving a right hand). The control device identifies, based on at least the determined moving entity and the determined movement type, a smart device (e.g., the smart television with serial number 12345) and an action for the smart device to take (e.g., turn on the sports channel) in response to the movement type by the moving entity.

In some cases, the control device receives, using an imaging unit and in conjunction with the radar signal, a camera signal. The control device preprocesses the camera signal to generate camera metadata. The moving entity and the movement type are determined based on a combination of the radar metadata and the camera metadata.

In some cases, the control device stores, in its memory, a map of a space surrounding the millimeter-wave multiple antenna array. The smart device may be identified based on a stored position of the smart device on the map, the determined moving entity, and the determined movement type. For example, if a person points his/her finger at the television, the television may be turned on (if it was previously off) or off (if it was previously on). If a person points his/her finger at the lamp, the lamp may be turned on (if it was previously off) or off (if it was previously on). Alternatively, the map itself may be updated based on the radar observations (or other observations, e.g., camera observations). For instance, moving an object from one point to another would update the location of the object on the stored map.

In some cases, the action for the smart device to take may be based on a previous state of the smart device. For example, in response to the movement type by the moving entity, a smart lamp may be turned on if it was previously off or turned off if it was previously on. A smart audio player may turn on and play Beethoven if it is off, play Chopin if it was previously playing Beethoven, play Mozart if it was previously playing Chopin, and turn off if it was previously playing Mozart.

The control device or one or more of the smart devices may be or may include a computing machine. As used herein, the phrase “computing machine” encompasses its plain and ordinary meaning. A “computing machine” may include one or more computing machines. A computing machine may include one or more of a server, a data repository, a client device, and the like. A computing machine may be any device or set of devices that, alone or in combination, includes processing circuitry and memory.

Aspects of the present invention may be implemented as part of a computer system. The computer system may be one physical machine, or may be distributed among multiple physical machines, such as by role or function, or by process thread in the case of a cloud computing distributed model. In various embodiments, aspects of the invention may be configured to run in virtual machines that in turn are executed on one or more physical machines. It will be understood by persons of skill in the art that features of the invention may be realized by a variety of different suitable machine implementations.

The system includes various engines, each of which is constructed, programmed, configured, or otherwise adapted, to carry out a function or set of functions. The term engine as used herein means a tangible device, component, or arrangement of components implemented using hardware, such as by an application specific integrated circuit (ASIC) or field-programmable gate array (FPGA), for example, or as a combination of hardware and software, such as by a processor-based computing platform and a set of program instructions that transform the computing platform into a special-purpose device to implement the particular functionality. An engine may also be implemented as a combination of the two, with certain functions facilitated by hardware alone, and other functions facilitated by a combination of hardware and software.

In an example, the software may reside in executable or non-executable form on a tangible machine-readable storage medium. Software residing in non-executable form may be compiled, translated, or otherwise converted to an executable form prior to, or during, runtime. In an example, the software, when executed by the underlying hardware of the engine, causes the hardware to perform the specified operations. Accordingly, an engine is physically constructed, or specifically configured (e.g., hardwired), or temporarily configured (e.g., programmed) to operate in a specified manner or to perform part or all of any operations described herein in connection with that engine.

Considering examples in which engines are temporarily configured, each of the engines may be instantiated at different moments in time. For example, where the engines comprise a general-purpose hardware processor core configured using software; the general-purpose hardware processor core may be configured as respective different engines at different times. Software may accordingly configure a hardware processor core, for example, to constitute a particular engine at one instance of time and to constitute a different engine at a different instance of time.

In certain implementations, at least a portion, and in some cases, all, of an engine may be executed on the processor(s) of one or more computers that execute an operating system, system programs, and application programs, while also implementing the engine using multitasking, multithreading, distributed (e.g., cluster, peer-peer, cloud, etc.) processing where appropriate, or other such techniques. Accordingly, each engine may be realized in a variety of suitable configurations, and should generally not be limited to any particular implementation exemplified herein, unless such limitations are expressly called out.

In addition, an engine may itself be composed of more than one sub-engines, each of which may be regarded as an engine in its own right. Moreover, in the embodiments described herein, each of the various engines corresponds to a defined functionality; however, it should be understood that in other contemplated embodiments, each functionality may be distributed to more than one engine. Likewise, in other contemplated embodiments, multiple defined functionalities may be implemented by a single engine that performs those multiple functions, possibly alongside other functions, or distributed differently among a set of engines than specifically illustrated in the examples herein.

Some aspects describe certain method operations as being performed in a given order or in series. However, unless specified otherwise, the method operations may be performed in any order and two or more operations may be performed in parallel. In some cases, some of the operation(s) of the method(s) may be skipped and/or replaced with other operation(s). In some cases, additional operation(s) may be added to one or more of the method(s) disclosed herein.

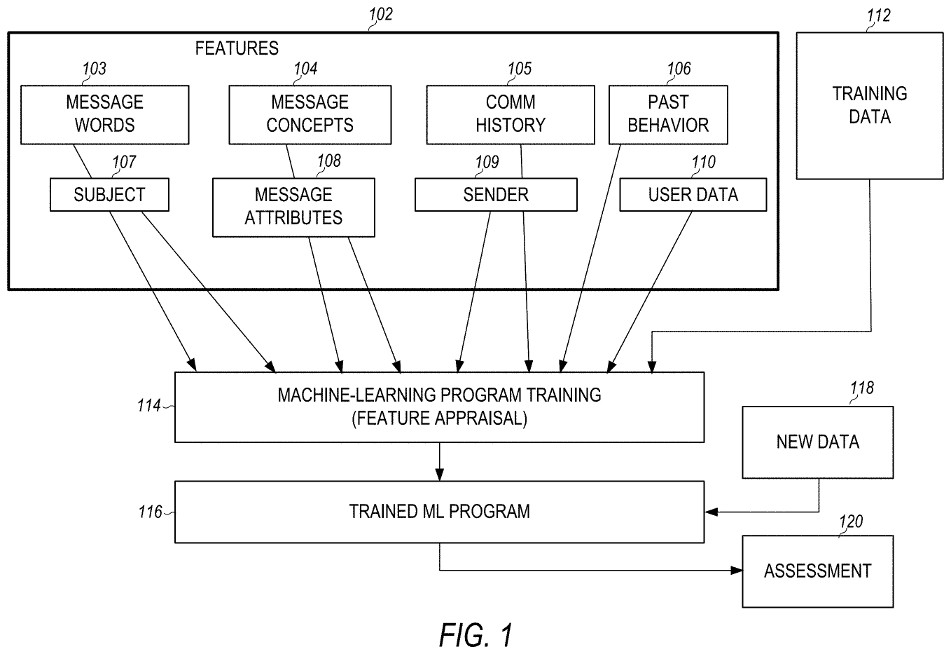

FIG. 1 illustrates the training and use of a machine-learning program, according to some example embodiments. In some example embodiments, machine-learning programs (MLPs), also referred to as machine-learning algorithms or tools, are utilized to perform operations associated with machine learning tasks, such as image recognition or machine translation.

Machine learning is a field of study that gives computers the ability to learn without being explicitly programmed. Machine learning explores the study and construction of algorithms, also referred to herein as tools, which may learn from existing data and make predictions about new data. Such machine-learning tools operate by building a model from example training data 112 in order to make data-driven predictions or decisions expressed as outputs or assessments 120. Although example embodiments are presented with respect to a few machine-learning tools, the principles presented herein may be applied to other machine-learning tools.

In some example embodiments, different machine-learning tools may be used. For example, Logistic Regression (LR), Naive-Bayes, Random Forest (RF), neural networks (NN), matrix factorization, and Support Vector Machines (SVM) tools may be used for classifying or scoring job postings.

Two common types of problems in machine learning are classification problems and regression problems. Classification problems, also referred to as categorization problems, aim at classifying items into one of several category values (for example, is this object an apple or an orange). Regression algorithms aim at quantifying some items (for example, by providing a value that is a real number). The machine-learning algorithms utilize the training data 112 to find correlations among identified features 102 that affect the outcome.

The machine-learning algorithms utilize features 102 for analyzing the data to generate assessments 120. A feature 102 is an individual measurable property of a phenomenon being observed. The concept of a feature is related to that of an explanatory variable used in statistical techniques such as linear regression. Choosing informative, discriminating, and independent features is important for effective operation of the MLP in pattern recognition, classification, and regression. Features may be of different types, such as numeric features, strings, and graphs.

In one example embodiment, the features 102 may be of different types and may include one or more of words of the message 103, message concepts 104, communication history 105, past user behavior 106, subject of the message 107, other message attributes 108, sender 109, and user data 110.

The machine-learning algorithms utilize the training data 112 to find correlations among the identified features 102 that affect the outcome or assessment 120. In some example embodiments, the training data 112 includes labeled data, which is known data for one or more identified features 102 and one or more outcomes, such as detecting communication patterns, detecting the meaning of the message, generating a summary of the message, detecting action items in the message, detecting urgency in the message, detecting a relationship of the user to the sender, calculating score attributes, calculating message scores, etc.

With the training data 112 and the identified features 102, the machine-learning tool is trained at operation 114. The machine-learning tool appraises the value of the features 102 as they correlate to the training data 112. The result of the training is the trained machine-learning program 116.

When the machine-learning program 116 is used to perform an assessment, new data 118 is provided as an input to the trained machine-learning program 116, and the machine-learning program 116 generates the assessment 120 as output. For example, when a message is checked for an action item, the machine-learning program utilizes the message content and message metadata to determine if there is a request for an action in the message.

Machine learning techniques train models to accurately make predictions on data fed into the models (e.g., what was said by a user in a given utterance; whether a noun is a person, place, or thing; what the weather will be like tomorrow). During a learning phase, the models are developed against a training dataset of inputs to optimize the models to correctly predict the output for a given input. Generally, the learning phase may be supervised, semi-supervised, or unsupervised, indicating a decreasing level to which the “correct” outputs are provided in correspondence to the training inputs. In a supervised learning phase, all of the outputs are provided to the model and the model is directed to develop a general rule or algorithm that maps the input to the output. In contrast, in an unsupervised learning phase, the desired output is not provided for the inputs so that the model may develop its own rules to discover relationships within the training dataset. In a semi-supervised learning phase, an incompletely labeled training set is provided, with some of the outputs known and some unknown for the training dataset.

Models may be run against a training dataset for several epochs (e.g., iterations), in which the training dataset is repeatedly fed into the model to refine its results. For example, in a supervised learning phase, a model is developed to predict the output for a given set of inputs, and is evaluated over several epochs to more reliably provide the output that is specified as corresponding to the given input for the greatest number of inputs for the training dataset. In another example, for an unsupervised learning phase, a model is developed to cluster the dataset into n groups, and is evaluated over several epochs as to how consistently it places a given input into a given group and how reliably it produces the n desired clusters across each epoch.

Once an epoch is run, the models are evaluated and the values of their variables are adjusted to attempt to better refine the model in an iterative fashion. In various aspects, the evaluations are biased against false negatives, biased against false positives, or evenly biased with respect to the overall accuracy of the model. The values may be adjusted in several ways depending on the machine learning technique used. For example, in a genetic or evolutionary algorithm, the values for the models that are most successful in predicting the desired outputs are used to develop values for models to use during the subsequent epoch, which may include random variation/mutation to provide additional data points. One of ordinary skill in the art will be familiar with several other machine learning algorithms that may be applied with the present disclosure, including linear regression, random forests, decision tree learning, neural networks, deep neural networks, etc.

Each model develops a rule or algorithm over several epochs by varying the values of one or more variables affecting the inputs to more closely map to a desired result, but as the training dataset may be varied, and is preferably very large, perfect accuracy and precision may not be achievable. A number of epochs that make up a learning phase, therefore, may be set as a given number of trials or a fixed time/computing budget, or may be terminated before that number/budget is reached when the accuracy of a given model is high enough or low enough or an accuracy plateau has been reached. For example, if the training phase is designed to run n epochs and produce a model with at least 95% accuracy, and such a model is produced before the n^{th} epoch, the learning phase may end early and use the produced model, satisfying the end-goal accuracy threshold. Similarly, if a given model is inaccurate enough to satisfy a random chance threshold (e.g., the model is only 55% accurate in determining true/false outputs for given inputs), the learning phase for that model may be terminated early, although other models in the learning phase may continue training. Similarly, when a given model continues to provide similar accuracy or vacillate in its results across multiple epochs—having reached a performance plateau—the learning phase for the given model may terminate before the epoch number/computing budget is reached.

Once the learning phase is complete, the models are finalized. In some example embodiments, models that are finalized are evaluated against testing criteria. In a first example, a testing dataset that includes known outputs for its inputs is fed into the finalized models to determine an accuracy of the model in handling data that it has not been trained on. In a second example, a false positive rate or false negative rate may be used to evaluate the models after finalization. In a third example, a delineation between data clusterings is used to select a model that produces the clearest bounds for its clusters of data.

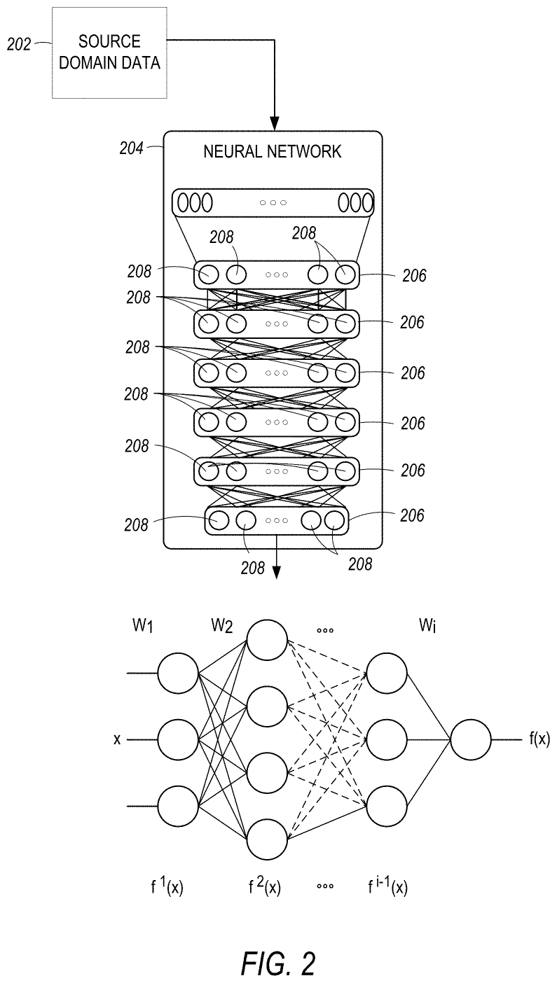

FIG. 2 illustrates an example neural network 204, in accordance with some embodiments. As shown, the neural network 204 receives, as input, source domain data 202. The input is passed through a plurality of layers 206 to arrive at an output. Each layer 206 includes multiple neurons 208. The neurons 208 receive input from neurons of a previous layer 206 and apply weights to the values received from those neurons 208 in order to generate a neuron output. The neuron outputs from the final layer 206 are combined to generate the output of the neural network 204.

As illustrated at the bottom of FIG. 2, the input is a vector x. The input is passed through multiple layers 206, where weights W₁, W₂, . . . , Wᵢ are applied to the input to each layer to arrive at f¹(x), f²(x), . . . , fⁱ⁻¹(x), until finally the output f(x) is computed.

In some example embodiments, the neural network 204 (e.g., deep learning, deep convolutional, or recurrent neural network) comprises a series of neurons 208, such as Long Short Term Memory (LSTM) nodes, arranged into a network. A neuron 208 is an architectural element used in data processing and artificial intelligence, particularly machine learning, which includes memory that may determine when to “remember” and when to “forget” values held in that memory based on the weights of inputs provided to the given neuron 208. Each of the neurons 208 used herein is configured to accept a predefined number of inputs from other neurons 208 in the neural network 204 to provide relational and sub-relational outputs for the content of the frames being analyzed. Individual neurons 208 may be chained together and/or organized into tree structures in various configurations of neural networks to provide interactions and relationship learning modeling for how each of the frames in an utterance are related to one another.

For example, an LSTM serving as a neuron includes several gates to handle input vectors (e.g., phonemes from an utterance), a memory cell, and an output vector (e.g., contextual representation). The input gate and output gate control the information flowing into and out of the memory cell, respectively, whereas forget gates optionally remove information from the memory cell based on the inputs from linked cells earlier in the neural network. Weights and bias vectors for the various gates are adjusted over the course of a training phase, and once the training phase is complete, those weights and biases are finalized for normal operation. One of skill in the art will appreciate that neurons and neural networks may be constructed programmatically (e.g., via software instructions) or via specialized hardware linking each neuron to form the neural network.

Neural networks utilize features for analyzing the data to generate assessments (e.g., recognize units of speech). A feature is an individual measurable property of a phenomenon being observed. The concept of feature is related to that of an explanatory variable used in statistical techniques such as linear regression. Further, deep features represent the output of nodes in hidden layers of the deep neural network.

A neural network, sometimes referred to as an artificial neural network, is a computing system/apparatus based on consideration of biological neural networks of animal brains. Such systems/apparatus progressively improve performance, which is referred to as learning, to perform tasks, typically without task-specific programming. For example, in image recognition, a neural network may be taught to identify images that contain an object by analyzing example images that have been tagged with a name for the object and, having learnt the object and name, may use the analytic results to identify the object in untagged images. A neural network is based on a collection of connected units called neurons, where each connection, called a synapse, between neurons can transmit a unidirectional signal with an activating strength that varies with the strength of the connection. The receiving neuron can activate and propagate a signal to downstream neurons connected to it, typically based on whether the combined incoming signals, which are from potentially many transmitting neurons, are of sufficient strength, where strength is a parameter.

A deep neural network (DNN) is a stacked neural network, which is composed of multiple layers. The layers are composed of nodes, which are locations where computation occurs, loosely patterned on a neuron in the human brain, which fires when it encounters sufficient stimuli. A node combines input from the data with a set of coefficients, or weights, that either amplify or dampen that input, which assigns significance to inputs for the task the algorithm is trying to learn. These input-weight products are summed, and the sum is passed through what is called a node's activation function, to determine whether and to what extent that signal progresses further through the network to affect the ultimate outcome. A DNN uses a cascade of many layers of non-linear processing units for feature extraction and transformation. Each successive layer uses the output from the previous layer as input. Higher-level features are derived from lower-level features to form a hierarchical representation. The layers following the input layer may be convolution layers that produce feature maps that are filtering results of the inputs and are used by the next convolution layer.

In training of a DNN architecture, a regression, which is structured as a set of statistical processes for estimating the relationships among variables, can include a minimization of a cost function. The cost function may be implemented as a function to return a number representing how well the neural network performed in mapping training examples to correct output. In training, if the cost function value is not within a pre-determined range, based on the known training images, backpropagation is used, where backpropagation is a common method of training artificial neural networks that are used with an optimization method such as a stochastic gradient descent (SGD) method.

Use of backpropagation can include propagation and weight update. When an input is presented to the neural network, it is propagated forward through the neural network, layer by layer, until it reaches the output layer. The output of the neural network is then compared to the desired output, using the cost function, and an error value is calculated for each of the nodes in the output layer. The error values are propagated backwards, starting from the output, until each node has an associated error value which roughly represents its contribution to the original output. Backpropagation can use these error values to calculate the gradient of the cost function with respect to the weights in the neural network. The calculated gradient is fed to the selected optimization method to update the weights to attempt to minimize the cost function.

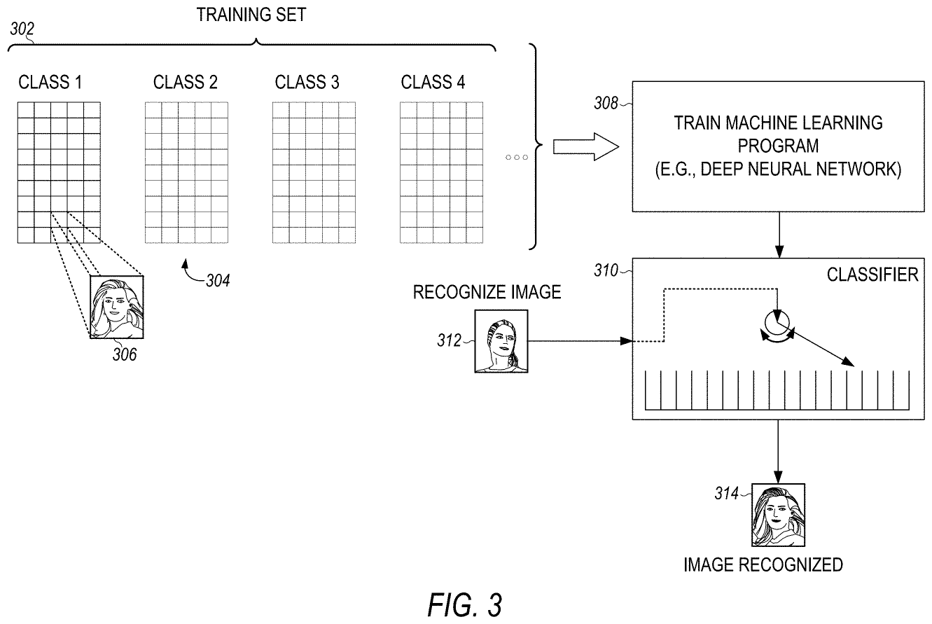

FIG. 3 illustrates the training of an image recognition machine learning program, in accordance with some embodiments. The machine learning program may be implemented at one or more computing machines. As shown, training set 302 includes multiple classes 304. Each class 304 includes multiple images 306 associated with the class. Each class 304 may correspond to a type of object in the image 306 (e.g., a digit 0-9, a man or a woman, a cat or a dog, etc.). In one example, the machine learning program is trained to recognize images of the presidents of the United States, and each class corresponds to each president (e.g., one class corresponds to Donald Trump, one class corresponds to Barack Obama, one class corresponds to George W. Bush, etc.). At block 308 the machine learning program is trained, for example, using a deep neural network. The trained classifier 310, generated by the training of block 308, recognizes an image 312, and at block 314 the image is recognized. For example, if the image 312 is a photograph of Bill Clinton, the classifier recognizes the image as corresponding to Bill Clinton at block 314.

FIG. 3 illustrates the training of a classifier, according to some example embodiments. A machine learning algorithm is designed for recognizing faces, and a training set 302 includes data that maps a sample to a class 304 (e.g., a class includes all the images of purses). The classes may also be referred to as labels or annotations. Although embodiments presented herein are presented with reference to object recognition, the same principles may be applied to train machine-learning programs used for recognizing any type of items.

The training set 302 includes a plurality of images 306 for each class 304 (e.g., image 306), and each image is associated with one of the categories to be recognized (e.g., a class). The machine learning program is trained at block 308 with the training data to generate a classifier at block 310 operable to recognize images. In some example embodiments, the machine learning program is a DNN.

When an input image 312 is to be recognized, the classifier 310 analyzes the input image 312 to identify the class corresponding to the input image 312. This class is labeled in the recognized image at block 314.

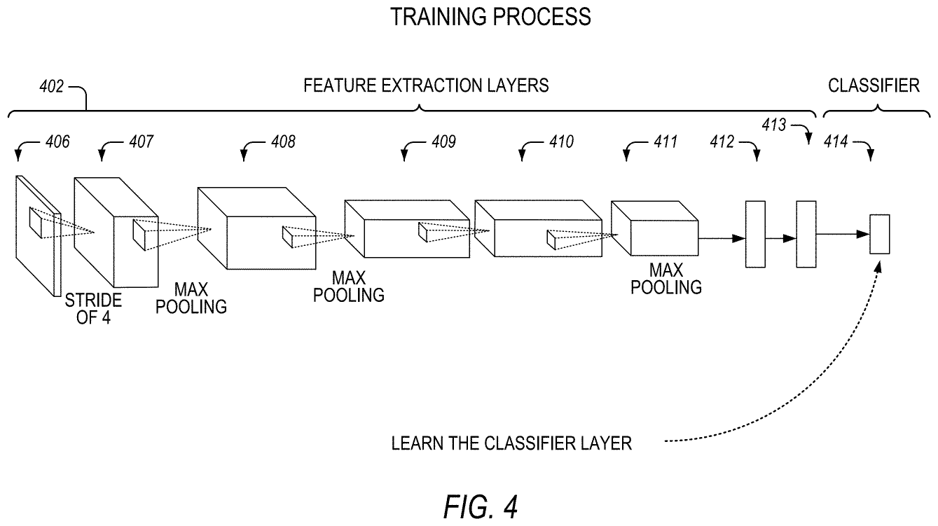

FIG. 4 illustrates the feature-extraction process and classifier training, according to some example embodiments. Training the classifier may be divided into feature extraction layers 402 and classifier layer 414. Each image is analyzed in sequence by a plurality of layers 406-413 in the feature-extraction layers 402.

With the development of deep convolutional neural networks, the focus in face recognition has been to learn a good face feature space, in which faces of the same person are close to each other, and faces of different persons are far away from each other. For example, the verification task with the LFW (Labeled Faces in the Wild) dataset has often been used for face verification.

Many face identification tasks (e.g., MegaFace and LFW) are based on a similarity comparison between the images in the gallery set and the query set, which is essentially a K-nearest-neighborhood (KNN) method to estimate the person's identity. In the ideal case, there is a good face feature extractor (inter-class distance is always larger than the intra-class distance), and the KNN method is adequate to estimate the person's identity.

Feature extraction is a process to reduce the amount of resources required to describe a large set of data. When performing analysis of complex data, one of the major problems stems from the number of variables involved. Analysis with a large number of variables generally requires a large amount of memory and computational power, and it may cause a classification algorithm to overfit to training samples and generalize poorly to new samples. Feature extraction is a general term describing methods of constructing combinations of variables to get around these large data-set problems while still describing the data with sufficient accuracy for the desired purpose.

In some example embodiments, feature extraction starts from an initial set of measured data and builds derived values (features) intended to be informative and non-redundant, facilitating the subsequent learning and generalization steps. Further, feature extraction is related to dimensionality reduction, such as by reducing large vectors (sometimes with very sparse data) to smaller vectors capturing the same, or similar, amount of information.

Determining a subset of the initial features is called feature selection. The selected features are expected to contain the relevant information from the input data, so that the desired task can be performed by using this reduced representation instead of the complete initial data. DNN utilizes a stack of layers, where each layer performs a function. For example, the layer could be a convolution, a non-linear transform, the calculation of an average, etc. Eventually this DNN produces outputs by classifier 414. In FIG. 4, the data travels from left to right as the features are extracted. The goal of training the neural network is to find the parameters of all the layers that make them adequate for the desired task.

As shown in FIG. 4, a “stride of 4” filter is applied at layer 406, and max pooling is applied at layers 407-413. The stride controls how the filter convolves around the input volume. “Stride of 4” refers to the filter convolving around the input volume four units at a time. Max pooling refers to down-sampling by selecting the maximum value in each max pooled region.

In some example embodiments, the structure of each layer is predefined. For example, a convolution layer may contain small convolution kernels and their respective convolution parameters, and a summation layer may calculate the sum, or the weighted sum, of two pixels of the input image. Training assists in defining the weight coefficients for the summation.

One way to improve the performance of DNNs is to identify newer structures for the feature-extraction layers, and another way is by improving the way the parameters are identified at the different layers for accomplishing a desired task. The challenge is that for a typical neural network, there may be millions of parameters to be optimized. Trying to optimize all these parameters from scratch may take hours, days, or even weeks, depending on the amount of computing resources available and the amount of data in the training set.

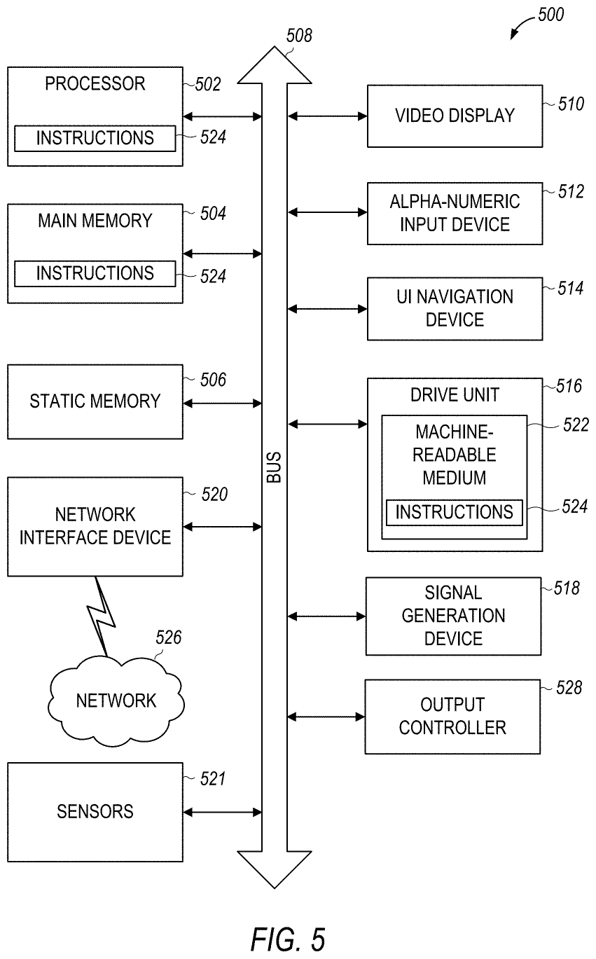

FIG. 5 illustrates a block diagram of a computing machine 500 in accordance with some embodiments. In some embodiments, the computing machine 500 may store the components shown in the circuit block diagram of FIG. 5. For example, circuitry that resides in the processor 502 and may be referred to as “processing circuitry.” Processing circuitry may include processing hardware, for example, one or more central processing units (CPUs), one or more graphics processing units (GPUs), and the like. In alternative embodiments, the computing machine 500 may operate as a standalone device or may be connected (e.g., networked) to other computers. In a networked deployment, the computing machine 500 may operate in the capacity of a server, a client, or both in server-client network environments. In an example, the computing machine 500 may act as a peer machine in peer-to-peer (P2P) (or other distributed) network environment. In this document, the phrases P2P, device-to-device (D2D) and sidelink may be used interchangeably. The computing machine 500 may be a specialized computer, a personal computer (PC), a tablet PC, a personal digital assistant (PDA), a mobile telephone, a smart phone, a web appliance, a network router, switch or bridge, or any machine capable of executing instructions (sequential or otherwise) that specify actions to be taken by that machine.

Examples, as described herein, may include, or may operate on, logic or a number of components, modules, or mechanisms. Modules and components are tangible entities (e.g., hardware) capable of performing specified operations and may be configured or arranged in a certain manner. In an example, circuits may be arranged (e.g., internally or with respect to external entities such as other circuits) in a specified manner as a module. In an example, the whole or part of one or more computer systems/apparatus (e.g., a standalone, client or server computer system) or one or more hardware processors may be configured by firmware or software (e.g., instructions, an application portion, or an application) as a module that operates to perform specified operations. In an example, the software may reside on a machine readable medium. In an example, the software, when executed by the underlying hardware of the module, causes the hardware to perform the specified operations.

Accordingly, the term “module” (and “component”) is understood to encompass a tangible entity, be that an entity that is physically constructed, specifically configured (e.g., hardwired), or temporarily (e.g., transitorily) configured (e.g., programmed) to operate in a specified manner or to perform part or all of any operation described herein. Considering examples in which modules are temporarily configured, each of the modules need not be instantiated at any one moment in time. For example, where the modules comprise a general-purpose hardware processor configured using software, the general-purpose hardware processor may be configured as respective different modules at different times. Software may accordingly configure a hardware processor, for example, to constitute a particular module at one instance of time and to constitute a different module at a different instance of time.

The computing machine 500 may include a hardware processor 502 (e.g., a central processing unit (CPU), a GPU, a hardware processor core, or any combination thereof), a main memory 504 and a static memory 506, some or all of which may communicate with each other via an interlink (e.g., bus) 508. Although not shown, the main memory 504 may contain any or all of removable storage and non-removable storage, volatile memory, or non-volatile memory. The computing machine 500 may further include a video display unit 510 (or other display unit), an alphanumeric input device 512 (e.g., a keyboard), and a user interface (UI) navigation device 514 (e.g., a mouse). In an example, the display unit 510, input device 512 and UI navigation device 514 may be a touch screen display. The computing machine 500 may additionally include a storage device (e.g., drive unit) 516, a signal generation device 518 (e.g., a speaker), a network interface device 520, and one or more sensors 521, such as a global positioning system (GPS) sensor, compass, accelerometer, or other sensor. The computing machine 500 may include an output controller 528, such as a serial (e.g., universal serial bus (USB), parallel, or other wired or wireless (e.g., infrared (IR), near field communication (NFC), etc.) connection to communicate or control one or more peripheral devices (e.g., a printer, card reader, etc.).

The drive unit 516 (e.g., a storage device) may include a machine readable medium 522 on which is stored one or more sets of data structures or instructions 524 (e.g., software) embodying or utilized by any one or more of the techniques or functions described herein. The instructions 524 may also reside, completely or at least partially, within the main memory 504, within static memory 506, or within the hardware processor 502 during execution thereof by the computing machine 500. In an example, one or any combination of the hardware processor 502, the main memory 504, the static memory 506, or the storage device 516 may constitute machine readable media.

While the machine readable medium 522 is illustrated as a single medium, the term “machine readable medium” may include a single medium or multiple media (e.g., a centralized or distributed database, and/or associated caches and servers) configured to store the one or more instructions 524.

The term “machine readable medium” may include any medium that is capable of storing, encoding, or carrying instructions for execution by the computing machine 500 and that cause the computing machine 500 to perform any one or more of the techniques of the present disclosure, or that is capable of storing, encoding or carrying data structures used by or associated with such instructions. Non-limiting machine readable medium examples may include solid-state memories, and optical and magnetic media. Specific examples of machine readable media may include: non-volatile memory, such as semiconductor memory devices (e.g., Electrically Programmable Read-Only Memory (EPROM), Electrically Erasable Programmable Read-Only Memory (EEPROM)) and flash memory devices; magnetic disks, such as internal hard disks and removable disks; magneto-optical disks; Random Access Memory (RAM); and CD-ROM and DVD-ROM disks. In some examples, machine readable media may include non-transitory machine-readable media. In some examples, machine readable media may include machine readable media that is not a transitory propagating signal.

The instructions 524 may further be transmitted or received over a communications network 526 using a transmission medium via the network interface device 520 utilizing any one of a number of transfer protocols (e.g., frame relay, internet protocol (IP), transmission control protocol (TCP), user datagram protocol (UDP), hypertext transfer protocol (HTTP), etc.). Example communication networks may include a local area network (LAN), a wide area network (WAN), a packet data network (e.g., the Internet), mobile telephone networks (e.g., cellular networks), Plain Old Telephone (POTS) networks, and wireless data networks (e.g., Institute of Electrical and Electronics Engineers (IEEE) 802.11 family of standards known as Wi-Fi®, IEEE 802.16 family of standards known as WiMax®), IEEE 802.15.4 family of standards, a Long Term Evolution (LTE) family of standards, a Universal Mobile Telecommunications System (UMTS) family of standards, peer-to-peer (P2P) networks, among others. In an example, the network interface device 520 may include one or more physical jacks (e.g., Ethernet, coaxial, or phone jacks) or one or more antennas to connect to the communications network 526.

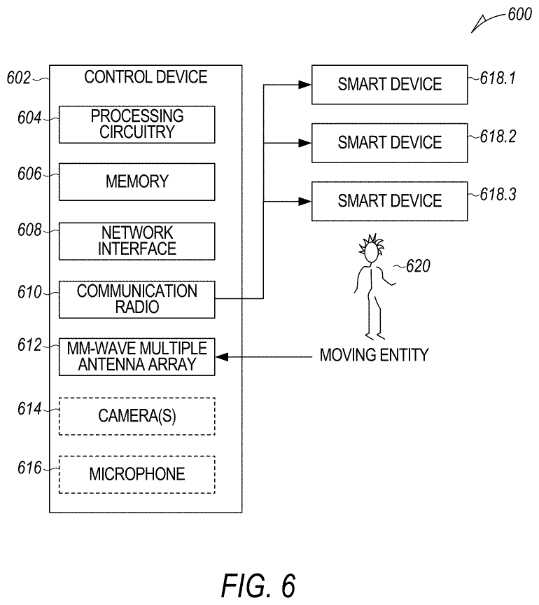

FIG. 6 is a block diagram of a system 600 in which smart device control using radar may be implemented, in accordance with some embodiments. The system 600 may be implemented in a home, an office, a shopping center, and the like. As shown, the system 600 includes a control device 602, smart devices 618.1-3, and a moving entity 620.

FIG. 6 is illustrated with three smart devices 618.1-3. However, the technology disclosed herein may be implemented in conjunction with any number of smart devices, not necessarily three. Each smart device 618.k (where k is a number between 1 and 3) may include one or more of: a smart light switch/lamp, a smart microwave, a smart oven, a smart tea or coffee maker, a smart television, a smart audio player, a smart microphone, a smart camera or monitoring device, a smart door, a smart lock, and a smart alarm. Each smart device 618.k may be any device that is capable of receiving and processing control signal(s) from the control device 602. Each smart device 618.k may include all or a portion of the components of the computing machine 500.

The control device 602 may include all or a portion of the components of the computing machine 500. As shown, the control device 602 includes processing circuitry 604, a memory 606, a network interface 608, a communication radio 610, a millimeter-wave (mm-wave) multiple antenna array 612, optional camera(s) 614, and an optional microphone 616.

The processing circuitry 604 executes instructions stored in the memory 606. The memory 606 stores data and/or instructions. The network interface 608 includes one or more network interface cards (NICs) and allows the control device 602 to communicate over network(s), for example, the Internet, a WiFi® network, a cellular network, and the like. The communication radio 610 may include one or more radios for communication with the smart devices 618.1-3. The communication radio 610 may communicate using one or more of Bluetooth®, WiFi®, a local area network, and the like. The mm-wave multiple antenna array 612 receives radar signals that may correspond to movement by the moving entity 620. The mm-wave multiple antenna array 612 may include Multiple Input Multiple Output (MIMO) unit(s). The camera(s) 614 receive visual data for processing in conjunction with the radar signals. The microphone 616 receives audio data for processing in conjunction with the radar signals.

As shown in FIG. 6, the control device 602 is a single device and the components 604-616 reside within the control device 602. However, in alternative embodiments, different components 604-616 may be separated from one another and may communicate with one another using various network, wired, and/or wireless connections. For example, multiple camera(s) 614 may be located in different parts of a room and may be connected to the control device 602 using universal serial bus (USB) connections. The microphone 616 may be connected to the control device 602 using a Bluetooth® connection.

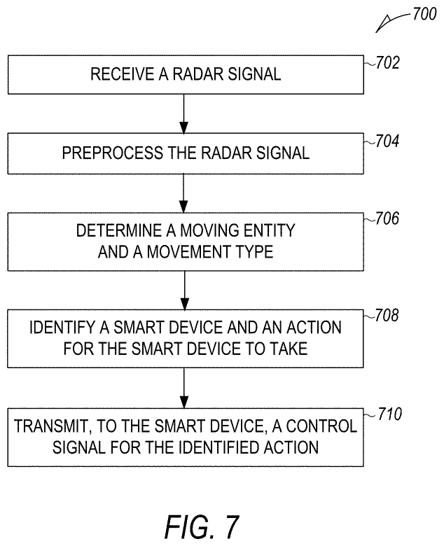

According to some embodiments, the processing circuitry 604, when executing instructions stored in the memory 606, receives, using the mm-wave multiple antenna array 612, a radar signal. The processing circuitry 604 preprocesses the radar signal to generate radar metadata. The processing circuitry 604 determines, using a trained machine learning engine and based on at least the radar metadata, the moving entity 620 and a movement type. The processing circuitry 604 identifies, based on at least the determined moving entity 620 and the determined movement type, a smart device 618.k and an action for the smart device 618.k to take in response to the movement type by the moving entity. The processing circuitry 604 causes the communication radio 610 to communicate (e.g., transmit), to the smart device 618.k, a control signal for the identified action. Examples of operation of the control device 602 are described in more detail in conjunction with FIG. 7.

FIG. 7 is a flow chart of a method 700 for smart device control using radar, in accordance with some embodiments. Some aspects of the method 700 are described as being implemented using the system 600. However, the method 700 may be implemented in system(s) with structures different from that of the system 600.

At operation 702, a computer receives, using a millimeter-wave multiple antenna array (e.g., mm-wave multiple antenna array 612), a radar signal. The computer may correspond to and/or include components from the computing machine 500 of FIG. 5 and/or the control device 602 of FIG. 6. The radar signal may include one or more chirps, pulses or OFDM, FMCW (frequency modulated continuous wave) or SFCW (step frequency continuous wave) signals.

In some cases, the computer receives the radar signal in conjunction with other signal(s), for example, a camera signal from one or multiple cameras or an audio signal from a microphone. The camera signal may be preprocessed to generate camera metadata. The moving entity and the movement type may be determined based on the camera metadata. For example, a specific person (e.g., Barack Obama) may be recognized using facial recognition software or hardware applied to the camera metadata. In some embodiments, the camera signal may be received via an imaging unit that comprises two or more cameras, and the camera metadata may include depth data that is computed based on images from the two or more cameras. In some cases, the moving entity may be determined, in whole or in part, based on audio data from the microphone. For example, voice recognition technology may be used to recognize a person. Alternatively, the person may speak his/her name and the radar data may be used to confirm that the person is who he/she says he/she is.

At operation 704, the computer preprocesses the radar signal to generate radar metadata. Preprocessing the radar signal may include computing a range, a velocity or an angle of the moving entity using a Fast Fourier Transform (FFT).

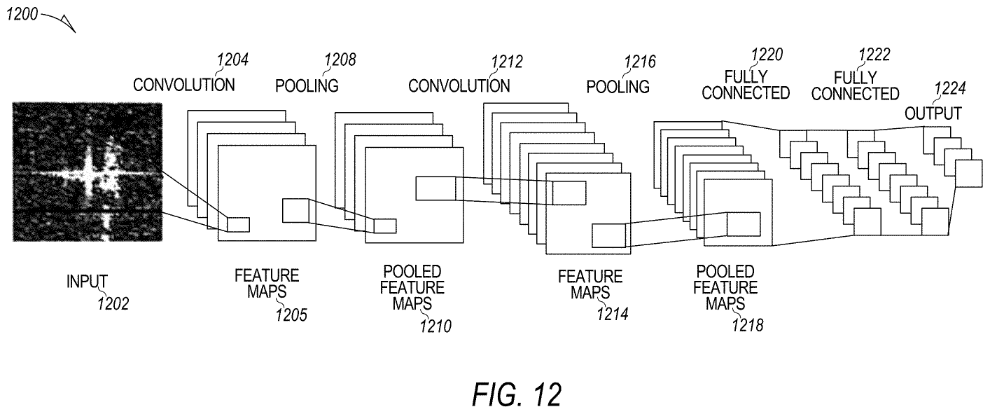

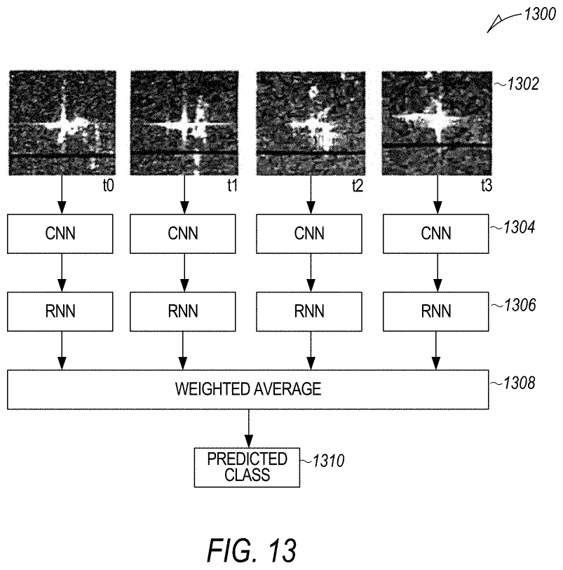

At operation 706, the computer determines, using a trained machine learning engine and based on at least the radar metadata, a moving entity and a movement type. The moving entity may include one or more of: a specific person (e.g., Donald Trump), a non-specific person (e.g., any person), an animal (e.g., a specific cat, any cat or any non-human animal), a moving object (e.g., a remote-controlled toy airplane, an electric toy train, a self-moving vacuum cleaner, and the like), and a group of moving persons, animals or objects (e.g., a person walking with a dog, two or more people walking with a dog, a child with a toy car, and the like). The moving entity and the movement type may be determined based on Micro-Doppler extraction or Range Doppler Angle profiles or radar point cloud data. The machine learning engine may be programmed or trained using any machine learning technique, for example, any of the techniques described in FIGS. 1-4 of this document may be used alone or in combination with one another. Additional examples of techniques for the machine learning engine are described in conjunction with FIGS. 12-13. In some embodiments, the trained machine learning engine comprises at least one convolutional neural network (CNN) and at least one recurrent neural network (RNN). (See FIG. 13.) In some embodiments, the trained machine learning engine comprises a CNN, which comprises a plurality of convolution layers and a plurality of pooling layers. (See FIG. 12.)

At operation 708, the computer identifies, based on at least the determined moving entity and the determined movement type, a smart device (e.g., smart device 618.1) and an action for the smart device to take in response to the movement type by the moving entity. The smart device may be selected from among multiple smart devices (e.g., smart devices 618.1-3).

In some cases, the computer stores, in its memory, a map of a space surrounding the millimeter-wave multiple antenna array. The smart device may be identified (e.g., from among the multiple smart devices) based on a stored position of the smart device on the map, the determined moving entity, and the determined movement type. For example, if a person points his/her finger at the television, the television may be turned on (if it was previously off) or off (if it was previously on). If a person points his/her finger at the lamp, the lamp may be turned on (if it was previously off) or off (if it was previously on).

At operation 710, the computer communicates, to the smart device, a control signal for the identified action. The control signal may be transmitted using a communication radio (e.g., communication radio 610) or, alternatively, using a wired connection (e.g. when the smart device is located within the same enclosure as the radar system). The communication to the smart device may include a transmission (e.g., wired or wireless transmission) to an external device or an internal communication within a single device (e.g., a transmission using the internal circuitry of the single device). Upon receiving the control signal, the smart device may perform the identified action.

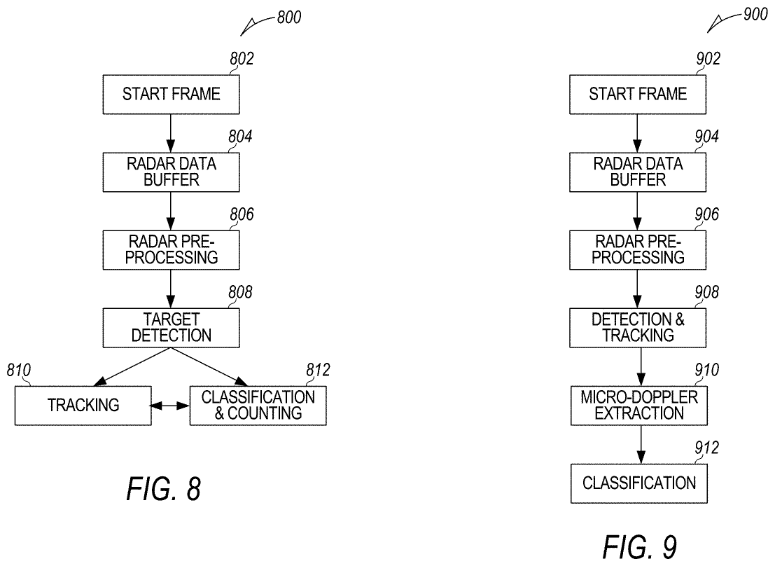

FIG. 8 is a flow chart of a method 800 for radar-based classification for person or animal detection and counting, in accordance with some embodiments. FIG. 8 illustrates a processing pipeline of radar only classification for person/animal detection and counting based on range doppler angle silhouette (RDAS).

The method 800 begins at start frame 802. At block 804, a computer receives a radar data buffer. At block 806, the radar data buffer is preprocessed. At block 808 a target (e.g., a moving entity, which may include one or more humans, animals or objects) is detected.

After block 808, blocks 810 and 812 may occur in parallel and may exchange data with one another. At block 810, the computer tracks the target. At block 812, the computer classifies and counts the target.

FIG. 9 is a flow chart of a method 900 for radar-based classification for person or animal identification or gesture recognition, based on micro-doppler data, in accordance with some embodiments.

The method 900 begins at start frame 902. At block 904, a computer receives a radar data buffer. At block 906, the radar data buffer is preprocessed. At block 908 a target (e.g., a moving entity, which may include one or more humans, animals or objects) is detected and tracked. At block 910, micro-doppler extraction is applied to the radar data buffer (received at block 904) with the detected target. At block 912, the target is classified.

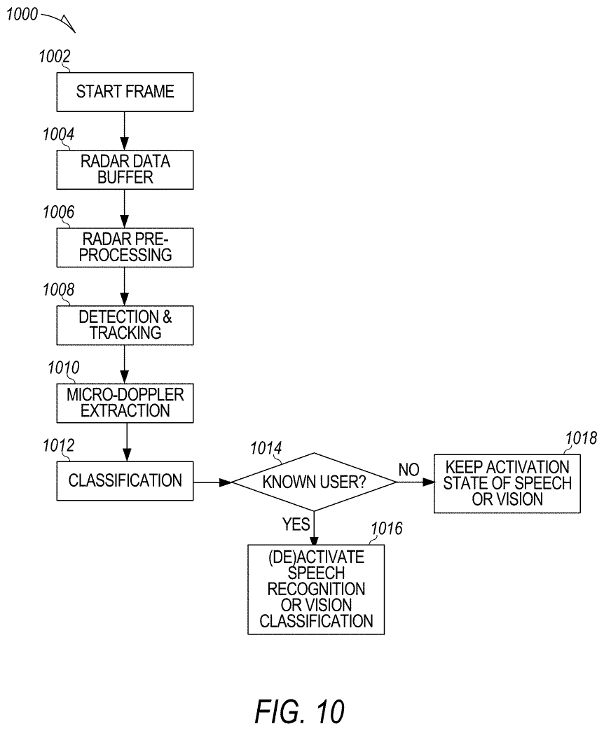

FIG. 10 is a flow chart of a method 1000 for radar-based person (or other entity) identification that activates or deactivates a speech recognition or vision classification machine, in accordance with some embodiments. In accordance with some embodiments described in FIG. 10, a radar processing device might always be turned on, and might be used to turn on other processing devices (e.g., a vision processing device/camera(s) or a speech processing device/microphone(s)) upon detecting a given moving entity. In accordance with some embodiments described in FIG. 10, the radar processing device identifies a person (e.g., based on gait or gesture(s)) and activates or deactivates the vision processing device and/or the speech processing device. This allows for two factor authentication (2FA) based on (i) the radar processing device, and (ii) the vision processing device and/or the speech processing device.

The method 1000 begins at start frame 1002. At block 1004, a computer receives a radar data buffer. At block 1006, the radar data buffer is preprocessed. At block 1008 a target (e.g., a moving entity, which may include one or more humans, animals or objects) is detected and tracked. At block 1010, micro-doppler extraction is applied to the radar data buffer with the detected target. At block 1012, the target is classified.

At block 1014, the computer determines whether the target includes a known user. If so, the method 1000 continues to operation 1016. If not, the method 1000 continues to operation 1018.

At block 1016, upon determining that the target includes a known user, the computer activates (e.g., if it was previously deactivated) or deactivates (e.g., in response to a specific gesture by the known user) a speech recognition device and/or a vision classification device. After block 1016, the method 1000 ends.

At block 1018, upon determining that the target does not include a known user, the computer maintains the previous activation state of the speech recognition device and/or the vision classification device. After block 1018, the method 1000 ends.

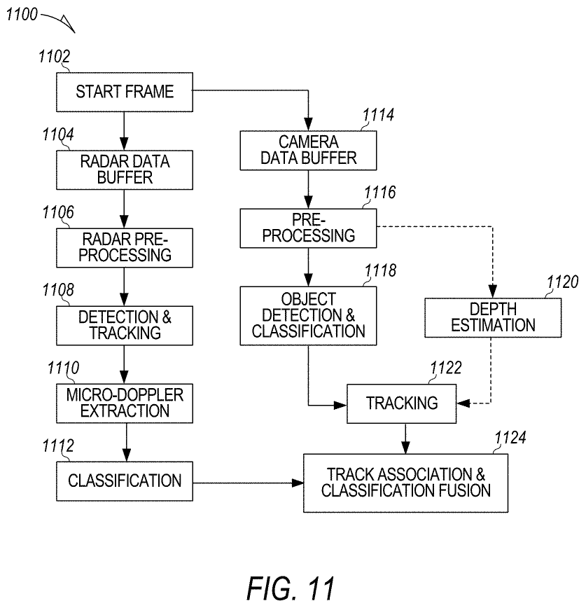

FIG. 11 is a flow chart of a method 1100 for radar and camera-based person (or other entity) identification, in accordance with some embodiments. In accordance with some embodiments of FIG. 11, a radar processing device and a vision processing device (e.g., including one or multiple cameras) are used together to identify target(s) (e.g., moving entities).

The method 1100 begins at start frame 1102. After start frame 1102, the radar processing operations 1104-1112 and the vision processing operations 1114-1122 may occur in parallel.

For the radar processing operations, at block 1104, a computer receives a radar data buffer. At block 1106, the radar data buffer is preprocessed. At block 1108 a target (e.g., a moving entity, which may include one or more humans, animals or objects) is detected and tracked using the radar data buffer. At block 1110, micro-doppler extraction is applied to the radar data buffer with the detected target. At block 1112, the target is classified.

For the vision processing operations, at block 1114, the computer receives a camera data buffer from one or multiple cameras. At block 1116, the camera data buffer is preprocessed. The preprocessing of the camera data buffer may include tone-mapping and other image correction algorithms (e.g., for mono or stereo images). The preprocessing may include image rectification for stereo images (if there are two or more cameras).

Blocks 1118 and 1120 may be processed in parallel. At block 1118, objects are detected and classified in the camera data buffer. Any image processing techniques may be used, for example, the machine learning techniques described in conjunction with FIGS. 1-4. At block 1120, if two or more cameras provide the camera data buffer, depth may be estimated for object(s) (e.g., the target(s)) in the camera data buffer.

At block 1122, target(s) and, possibly, other object(s) in the camera data buffer are tracked based on the calculations of blocks 1118 and 1120.

The outputs of block 1112 (radar classification) and block 1122 (visual tracking) are provided to block 1124. At block 1124, the radar classification data and the visual tracking data are combined to identify a moving entity and a movement type. The identified moving entity and the identified movement type may be used to identify a smart device and an action for the smart device to take. The computer may provide, to the smart device, a control signal for taking the action.

FIG. 12 is a data flow diagram 1200 for classification of a single-frame range doppler angle silhouette (RDAS) (for classification of a person or an animal either indoor or outdoor) using a deep convolutional neural network (CNN), in accordance with some embodiments. A similar pipeline may be used for micro-doppler classification (for person identification or gesture recognition).

At block 1202, a single-frame RDAS input is received. At block 1204, convolution is applied to the single-frame RDAS input to generate feature maps 1206. Pooling 1208 is applied to the feature maps 1206 to generate pooled feature maps 1210. Convolution 1212 is applied to the pooled feature maps 1210 to generate feature maps 1214. Pooling 1216 is applied to the feature maps 1214 to generate pooled feature maps 1218. The pooled feature maps 1218 are processed by fully connected layer 1220 and fully connected layer 1222 to generate the output 1224 (e.g., classification or target identification).

FIG. 13 data flow diagram 1300 for classification of sequence of RDASs (e.g., for person vs. animal classification or person vs. everything else classification) using a CNN-RNN combination, in accordance with some embodiments. Any CNN or RNN architecture can be used in conjunction with FIG. 13.

At block 1302, RDASs are received at multiple different times (e.g., t0, t1, t2, and t3). At block 1304, each RDAS is processed by a CNN. At block 1306, the output of each CNN is processed by a RNN. A block 1308, a weighted average of the RNN outputs is computed. At block 1310, a predicted class is identified based on the weighted average.

It should be noted that FIGS. 12-13 are provided for illustration purposes. Other architectures that have a different number or type of layers, and the like, may be used with the disclosed technology. For example a three-dimensional (3D) CNN may be used in addition to or in place of the CNN-RNN combination shown in FIG. 13. In another embodiment, a two-dimensional (2D) CNN followed by a one-dimensional (1D) CNN is used in addition to or in place of the CNN-RNN combination shown in FIG. 13.

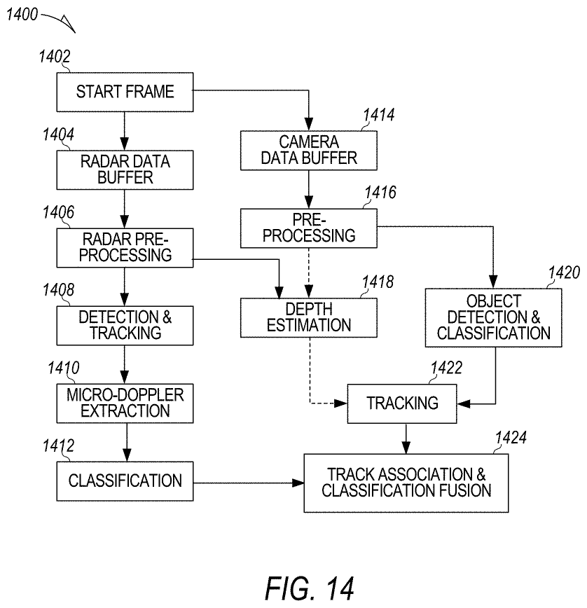

FIG. 14 is a flow chart of a first method 1400 for combining radar and camera data, in accordance with some embodiments. Fusion of depth information from the radar data and the visual information from the camera data may be useful, for example, in poor weather or illumination conditions or in an embodiment where a single camera is coupled with a radar processing device.

The method 1400 begins at start frame 1402. After start frame 1402, the radar processing operations 1404-1412 and the vision processing operations 1414-1422 may occur in parallel.

For the radar processing operations, at block 1404, a computer receives a radar data buffer. At block 1406, the radar data buffer is preprocessed. At block 1408 a target (e.g., a moving entity, which may include one or more humans, animals or objects) is detected and tracked using the radar data buffer. At block 1410, RDAS and micro-doppler extraction is applied to the radar data buffer with the detected target. At block 1412, the target is classified.

For the vision processing operations, at block 1414, the computer receives a camera data buffer from one or multiple cameras. At block 1416, the camera data buffer is preprocessed. The preprocessing of the camera data buffer may include tone-mapping and other image correction algorithms (e.g., for mono or stereo images). The preprocessing may include image rectification for stereo images (if there are two or more cameras).

Blocks 1418 and 1420 may be processed in parallel. At block 1418, depth is estimated. If two or more cameras provide the camera data buffer, depth may be estimated for object(s) (e.g., the target(s)) in the camera data buffer without relying on radar data. Alternatively or in addition to the above, preprocessed camera data (from one or more cameras) from block 1416 may be combined with preprocessed radar data from block 1406 to estimate depth for object(s). At block 1420, objects are detected and classified in the camera data buffer. Any image processing techniques may be used, for example, the machine learning techniques described in conjunction with FIGS. 1-4.

At block 1422, target(s) and, possibly, other object(s) in the camera data buffer are tracked based on the calculations of blocks 1418 and 1420.

The outputs of block 1412 (radar classification) and block 1422 (visual tracking) are provided to block 1424. At block 1424, the radar classification data and the visual tracking data are combined to identify a moving entity and a movement type. The identified moving entity and the identified movement type may be used to identify a smart device and an action for the smart device to take. The computer may provide, to the smart device, a control signal for taking the action.

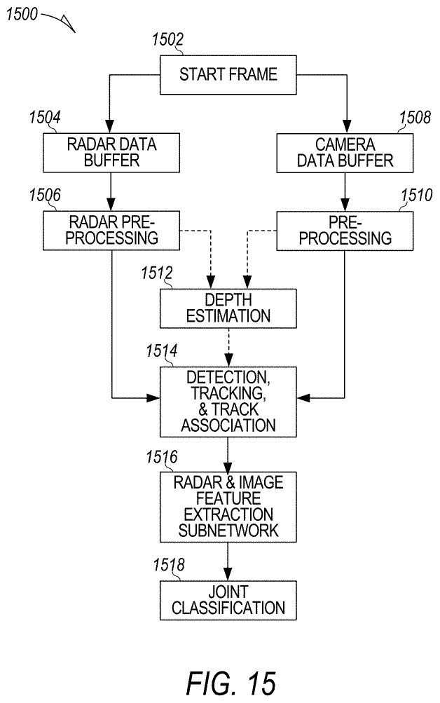

FIG. 15 is a flow chart of a second method 1500 for combining radar and camera data, in accordance with some embodiments.

The method 1500 begins at start frame 1502. After start frame 1502, the radar processing operations 1504-1506 and the vision processing operations 1508-1510 may occur in parallel.

For the radar processing operations, at block 1504, a computer receives a radar data buffer. At block 1506, the radar data buffer is preprocessed.

For the vision processing operations, at block 1508, the computer receives a camera data buffer from one or multiple cameras. At block 1510, the camera data buffer is preprocessed. The preprocessing of the camera data buffer may include tone-mapping and other image correction algorithms (e.g., for mono or stereo images). The preprocessing may include image rectification for stereo images (if there are two or more cameras).

At block 1512, depth is estimated based on the visual preprocessing 1510 and, in some cases, the radar preprocessing 1506. If two or more cameras provide the camera data buffer, depth may be estimated for object(s) (e.g., the target(s)) in the camera data buffer without relying on radar data. Alternatively or in addition to the above, preprocessed camera data (from one or more cameras) from block 1510 may be combined with preprocessed radar data from block 1506 to estimate depth for object(s).

At block 1514, the preprocessed radar data 1506, the preprocessed camera data 1510, and the depth estimation 1512 are combined to generate detection, tracking, and track association for target(s) (e.g., a moving entity).

At block 1516, radar and image features are extracted from the output of the detection, tracking, and track association of block 1514.

At block 1518, joints are classified based on the features extracted at block 1516. For example, a person's arm, leg, head, etc., may be identified as being moved and a movement type (e.g., pointing a finger, waving a hand, etc.) maybe identified. Any machine learning technique or combination of machine learning techniques may be used, for example, the machine learning techniques shown in FIGS. 1-4 or FIGS. 12-13.

Some embodiments provide a radar system to detect people or gestures/activities and/or to identify people in the vicinity. Some embodiments detects people and the number of people within some radius. Some embodiments identify specific persons (e.g., Donald Trump) or classify specific gestures/movements (e.g., hand wave, finger pointing, kicking a ball, etc.) based on radar features. Some benefits include low-cost, preserving privacy, and low electric power usage.

Some aspects use mm-wave (10 GHz-200 GHz) antennas. Some aspects use multiple antennas—at least three antennas for combined transmission (Tx) and reception (Rx). Some aspects use multi-frame detection and classification. A frame may include a measurement cycle between 10 microseconds and 100 milliseconds. Some aspects are designed to detect the presence, the number, and the identity of persons in a given environment. The radar sensor can work in combination with other sensors and/or actuators that are activated or deactivated by the radar sensor. For example, when a person enters a room (as detected by the radar processing system), a vision processing system may be turned on to enable facial recognition or an audio processing system may be turned on to enable speech recognition or voice-based identification.

Some embodiments include radar in combination with other sensors or an array of sensors (camera, speech, etc.). The radar sensor detects a feature and then activates the vision (or other) sensor. A feature may be the presence of a person (any person or a specific person), a hand gesture, a specific activity. In some embodiments, the radar is always turned on (or turned on/off by a manually-operated switch) while the camera is turned on after receiving a control signal from the radar sensor. The radar sensor activates the camera upon detecting the presence of a person or a specific gesture/command by the person. The camera may also be turned off (or placed into a deep sleep mode) using a gesture processed by the radar sensor.

In some embodiments, the radar sensor, based on receiving ranges/angles/ Doppler, point cloud data, or micro-Doppler information, may detect the presence of a specific user (e.g., George Bush). Based on the gesture(s) and/or the presence or position of the specific user, other sensors, actuators, alarm systems, or smart devices may be turned on, turned off or otherwise controlled.

In some aspects, the system also includes an audio input or output device. A combination of gesture and speech commands may be used to turn on, turn off or otherwise control the other sensors, actuators, and smart devices.

Example embodiments include a system that identifies a specific person and/or activity to trigger an alarm or a camera. Example embodiments include using specific gestures to activate specific devices (e.g., pointing in a direction). The gesture may be identified by the radar processing device and a map, stored in conjunction with the radar processing device, may be used to identify the smart device which the user is trying to control (e.g., by pointing to the smart device). Some locations may be deemed safe zones, causing a camera or microphone to turn off if the person enters the safe zone. In some cases, the radar unit may trigger cameras (or other smart devices) in a specific area. For example, when a person walks down a path, cameras or lights may be turned on when the person is proximate (e.g., within 10 meters) of them and turned off otherwise. Doors may be opened, closed, locked or unlocked based on the activity, the identity, and the location (zone) of a person. Lights, sound systems, curtains, and the like may be controlled in a similar manner.

In some embodiments, radar is used to find the range and angle of an incoming object. A camera with a limited field of vision (FOV) but high zoom may hone in on the incoming object. Illumination (e.g., by light, laser, etc.) may be guided by the radar. Radar may be used with an array of distributed cameras to decide which camera(s) to turn on and in which direction to point the camera(s). Alternatively, camera(s) may be used to turn on or off the radar processing device, when necessary. Radar may be used to identify people versus pets or animals in order to activate or deactivate other sensors or amenities or to turn on or off the animal feeder. For example, an animal feeder may be opened when any animal (or a specific animal) approaches it. Alternatively, a light in a room may be turned on when a resident of the home enters the room but not when another person or a pet enters the room.

A radar processing device (e.g., control device 602) may provide information to drive smart devices based on location, activity, identification, or any combination of the above (e.g., this person in that location). The location itself could trigger privacy or activate/deactivate the sensor(s) (“safe zone”). The input to the system, upon setup, could be a map of the region or room from the vision processing device. There may be two sets of inputs—prior data (from all sensors) and current input for inference (from the radar processing device). The radar processing device may activate or deactivate microphones, cameras, lights, doors, locks, music, alarms, and the like. The radar processing device may use a multi-frame or micro-Doppler as input to the trained machine learning engine.

The radar processing device (e.g., control device 602) may use multiple frames for detection and identification. A micro-Doppler of walking may be used to identify people as opposed to animals or to identify a specific person (e.g., John Sample vs. Jane Sample). In continuous learning mode, the computer uses speech to detect a person and then labels the person for radar. There could be cross-labeling with speech identification—a microphone array could add directionality. The camera may also provide cross-labeling.

Some aspects of the technology disclosed herein may be used in various use cases. For example, some embodiments can be used to provide perimeter security in place(s) where camera(s) would not be effective, for example, in dark or steamy places. For example, in a factory setting, some embodiments of the disclosed technology could be used to ensure that no people are present near a high temperature boiler (which produces steam) when the boiler is in operation or that no people (or only authorized people) are present in some other dangerous environment. Some embodiments of the technology could be used to provide security while preserving privacy in a home or office environment, as radar may be used in place of camera(s).

Some embodiments may be used in sports. For example, a radar processing device (e.g., control device 602) may operate as a virtual referee or a virtual coach in a sports game. As a referee, the radar system may determine whether certain movement(s) are consistent with the rules of the game or whether certain events took place (e.g., whether the ball entered the goal, whether a player touched the ball with his/her hand(s), what the speed of the movement or ball was, etc.). As a coach, the radar system could observe game play(s) and suggest improvements using an artificial intelligence engine or a knowledge engine that stores information about how to improve the game play.

Some embodiments may be used in child care. For example, a radar processing device may observe a small child's movement and alert caregiver if the child is beginning to do something dangerous (e.g., climb out of a child chair) or if an older child is leaving a room or a home. In some embodiments, a radar system may observe a sleeping child and a prediction engine may be used to predict when the sleeping child will wake up, so that the caregiver can be prepared when the child awakens.

Some embodiments of the disclosed technology may leverage multi-part training. A first part of the training of the radar processing device (e.g., control device 602) may be completed when the manufacturer builds and develops the system. At this time, the radar processing device may be trained to generally recognize people, animals, other moving objects, and gestures. A second part of the training of the radar processing device may be completed when the radar system is deployed (e.g., at the home or office of the end-user). At this time, the end-user may train the radar processing device to recognize specific people (e.g., Jack Sample and Jill Sample) and specific gestures to control specific smart device(s) and how to recognize different people. For example, the radar processing device may be trained to turn on the television when Jack waves his right hand while on the couch or when Jill wiggles her elbow while standing on the treadmill. To accomplish the personalized training of the radar classification algorithm, different embodiments can be used. In one embodiment, the radar system can be prompted to enter training mode. While in training mode, the detected target in the radar data would be associated with a specific person (e.g. Jack Sample) or gesture (e.g. fingers opening and closing) and annotated accordingly for use in retraining the algorithm. Another embodiment may use a combination of radar and another sensor (e.g., camera or microphone) such that the other sensor provides annotations for the captured radar data. For instance, a camera system that is already trained to detect and recognize Jack Sample based on face recognition can be used to automatically label the detected target in the radar data while Jack Sample is detected by the camera system as being present in the room. The radar algorithm is subsequently re-trained using data annotated by one or both of the above embodiment.

Some aspects of the technology disclosed herein are described below as examples. These examples do not limit the technology disclosed herein.

Example 1 is a system comprising: processing circuitry; and a memory storing instructions which, when executed by the processing circuitry, cause the processing circuitry to perform operations comprising: receiving, using a millimeter-wave multiple antenna array, a radar signal; preprocessing the radar signal to generate radar metadata; determining, using a trained machine learning engine and based on at least the radar metadata, a moving entity and a movement type; identifying, based on at least the determined moving entity and the determined movement type, a smart device and an action for the smart device to take in response to the movement type by the moving entity; and communicating, to the smart device, a control signal for the identified action.

In Example 2, the subject matter of Example 1 includes, wherein the moving entity comprises one or more of: a specific person, a non-specific person, an animal, a moving object, a group of moving persons, animals or objects.

In Example 3, the subject matter of Examples 1-2 includes, the operations further comprising: receiving, using an imaging unit and in conjunction with the radar signal, a camera signal; preprocessing the camera signal to generate camera metadata, wherein the moving entity and the movement type are determined based on the camera metadata.

In Example 4, the subject matter of Example 3 includes, wherein the imaging unit comprises two or more cameras, and wherein the camera metadata comprises depth data.

In Example 5, the subject matter of Examples 1-4 includes, the operations further comprising: receiving, using a microphone and in conjunction with the radar signal, an audio signal; preprocessing the audio signal to generate audio metadata, wherein the moving entity is determined based on the audio metadata.

In Example 6, the subject matter of Examples 1-5 includes, wherein the smart device comprises one or more of: a microphone, a camera, a lamp, a door, a lock, an audio player, a television, and an alarm.

In Example 7, the subject matter of Examples 1-6 includes, wherein: the radar signal comprises one or more chirps, pulses or orthogonal frequency-division multiplexing (OFDM), frequency modulated continuous wave (FMCW) or step-frequency continuous wave (SFCW) signals; and preprocessing the radar signal comprises computing a range, a velocity, or an angle of the moving entity using a fast Fourier transform (FFT).

In Example 8, the subject matter of Examples 1-7 includes, the operations further comprising: storing, in the memory, a map of a space surrounding the millimeter-wave multiple antenna array, wherein the smart device is identified based on a stored position of the smart device on the map, the determined moving entity, and the determined movement type.

In Example 9, the subject matter of Examples 1-8 includes, wherein determining the moving entity and the movement type is based on Micro-Doppler or Range Doppler Angle or point cloud data extraction.

In Example 10, the subject matter of Examples 1-9 includes, wherein the trained machine learning engine comprises at least one convolutional neural network (CNN) and at least one recurrent neural network (RNN).

In Example 11, the subject matter of Examples 1-10 includes, wherein the trained machine learning engine comprises a convolutional neural network (CNN), the CNN comprising a plurality of convolution layers and a plurality of pooling layers.

In Example 12, the subject matter of Examples 1-11 includes, the millimeter-wave multiple antenna array; and the smart device.

Example 13 is a non-transitory machine-readable medium storing instructions which, when executed by a computing machine, cause the computing machine to perform operations comprising: receiving, using a millimeter-wave multiple antenna array, a radar signal; preprocessing the radar signal to generate radar metadata; determining, using a trained machine learning engine and based on at least the radar metadata, a moving entity and a movement type; identifying, based on at least the determined moving entity and the determined movement type, a smart device and an action for the smart device to take in response to the movement type by the moving entity; and communicating, to the smart device, a control signal for the identified action.

In Example 14, the subject matter of Example 13 includes, wherein the moving entity comprises one or more of: a specific person, a non-specific person, an animal, a moving object, a group of moving persons, animals or objects.

In Example 15, the subject matter of Examples 13-14 includes, the operations further comprising: receiving, using an imaging unit and in conjunction with the radar signal, a camera signal; preprocessing the camera signal to generate camera metadata, wherein the moving entity and the movement type are determined based on the camera metadata.

In Example 16, the subject matter of Example 15 includes, wherein the imaging unit comprises two or more cameras, and wherein the camera metadata comprises depth data.

In Example 17, the subject matter of Examples 13-16 includes, the operations further comprising: receiving, using a microphone and in conjunction with the radar signal, an audio signal; preprocessing the audio signal to generate audio metadata, wherein the moving entity is determined based on the audio metadata.

In Example 18, the subject matter of Examples 13-17 includes, wherein the smart device comprises one or more of: a microphone, a camera, a lamp, a door, a lock, an audio player, a television, and an alarm.

In Example 19, the subject matter of Examples 13-18 includes, wherein: the radar signal comprises one or more chirps, pulses or orthogonal frequency-division multiplexing (OFDM) signals; and preprocessing the radar signal comprises computing a range, a velocity, or an angle of the moving entity using a fast Fourier transform (FFT).

Example 20 is a method comprising: receiving, using a millimeter-wave multiple antenna array, a radar signal; preprocessing the radar signal to generate radar metadata; determining, using a trained machine learning engine and based on at least the radar metadata, a moving entity and a movement type; identifying, based on at least the determined moving entity and the determined movement type, a smart device and an action for the smart device to take in response to the movement type by the moving entity; and communicating, to the smart device, a control signal for the identified action.

Example 21 is at least one machine-readable medium including instructions that, when executed by processing circuitry, cause the processing circuitry to perform operations to implement of any of Examples 1-20.

Example 22 is an apparatus comprising means to implement of any of Examples 1-20.

Example 23 is a system to implement of any of Examples 1-20.

Example 24 is a method to implement of any of Examples 1-20.

Although an embodiment has been described with reference to specific example embodiments, it will be evident that various modifications and changes may be made to these embodiments without departing from the broader spirit and scope of the present disclosure. Accordingly, the specification and drawings are to be regarded in an illustrative rather than a restrictive sense. The accompanying drawings that form a part hereof show, by way of illustration, and not of limitation, specific embodiments in which the subject matter may be practiced. The embodiments illustrated are described in sufficient detail to enable those skilled in the art to practice the teachings disclosed herein. Other embodiments may be utilized and derived therefrom, such that structural and logical substitutions and changes may be made without departing from the scope of this disclosure. This Detailed Description, therefore, is not to be taken in a limiting sense, and the scope of various embodiments is defined only by the appended claims, along with the full range of equivalents to which such claims are entitled.

Although specific embodiments have been illustrated and described herein, it should be appreciated that any arrangement calculated to achieve the same purpose may be substituted for the specific embodiments shown. This disclosure is intended to cover any and all adaptations or variations of various embodiments. Combinations of the above embodiments, and other embodiments not specifically described herein, will be apparent to those of skill in the art upon reviewing the above description.

In this document, the terms “a” or “an” are used, as is common in patent documents, to include one or more than one, independent of any other instances or usages of “at least one” or “one or more.” In this document, the term “or” is used to refer to a nonexclusive or, such that “A or B” includes “A but not B,” “B but not A,” and “A and B,” unless otherwise indicated. In this document, the terms “including” and “in which” are used as the plain-English equivalents of the respective terms “comprising” and “wherein.” Also, in the following claims, the terms “including” and “comprising” are open-ended, that is, a system, user equipment (UE), article, composition, formulation, or process that includes elements in addition to those listed after such a term in a claim are still deemed to fall within the scope of that claim. Moreover, in the following claims, the terms “first,” “second,” and “third,” etc., are used merely as labels, and are not intended to impose numerical requirements on their objects.

The Abstract of the Disclosure is provided to comply with 37 C.F.R. § 1.72(b), requiring an abstract that will allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in a single embodiment for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separate embodiment.

What is claimed is:

1. A system comprising:
processing circuitry; and
a memory storing instructions which, when executed by the processing circuitry, cause the processing circuitry to perform operations comprising:
receiving, using a millimeter-wave multiple antenna array, a radar signal;
preprocessing the radar signal to generate radar metadata;
determining, using a trained machine learning engine and based on at least the radar metadata, a moving entity and a movement type;
identifying, based on at least the determined moving entity and the determined movement type, a smart device and an action for the smart device to take in response to the movement type by the moving entity; and
communicating, to the smart device, a control signal for the identified action.

2. The system of claim 1, wherein the moving entity comprises one or more of: a specific person, a non-specific person, an animal, a moving object, a group of moving persons, animals or objects.

3. The system of claim 1, the operations further comprising:
receiving, using an imaging unit and in conjunction with the radar signal, a camera signal;
preprocessing the camera signal to generate camera metadata, wherein the moving entity and the movement type are determined based on the camera metadata.

4. The system of claim 3, wherein the imaging unit comprises two or more cameras, and wherein the camera metadata comprises depth data.

5. The system of claim 1, the operations further comprising:
receiving, using a microphone and in conjunction with the radar signal, an audio signal;
preprocessing the audio signal to generate audio metadata, wherein the moving entity is determined based on the audio metadata.

6. The system of claim 1, wherein the smart device comprises one or more of: a microphone, a camera, a lamp, a door, a lock, an audio player, a television, and an alarm.

7. The system of claim 1, wherein:
the radar signal comprises one or more chirps, pulses or orthogonal frequency-division multiplexing (OFDM), frequency modulated continuous wave (FMCW) or step-frequency continuous wave (SFCW) signals; and
preprocessing the radar signal comprises computing a range, a velocity, or an angle of the moving entity using a fast Fourier transform (FFT).

8. The system of claim 1, the operations further comprising:
storing, in the memory, a map of a space surrounding the millimeter-wave multiple antenna array, wherein the smart device is identified based on a stored position of the smart device on the map, the determined moving entity, and the determined movement type.

9. The system of claim 1, wherein determining the moving entity and the movement type is based on Micro-Doppler or Range Doppler Angle or point cloud data extraction.

10. The system of claim 1, wherein the trained machine learning engine comprises at least one convolutional neural network (CNN) and at least one recurrent neural network (RNN).

11. The system of claim 1, wherein the trained machine learning engine comprises a convolutional neural network (CNN), the CNN comprising a plurality of convolution layers and a plurality of pooling layers.

12. The system of claim 1, further comprising:
the millimeter-wave multiple antenna array; and
the smart device.

13. A non-transitory machine-readable medium storing instructions which, when executed by a computing machine, cause the computing machine to perform operations comprising:
receiving, using a millimeter-wave multiple antenna array, a radar signal;
preprocessing the radar signal to generate radar metadata;
determining, using a trained machine learning engine and based on at least the radar metadata, a moving entity and a movement type;
identifying, based on at least the determined moving entity and the determined movement type, a smart device and an action for the smart device to take in response to the movement type by the moving entity; and
communicating, to the smart device, a control signal for the identified action.

14. The machine-readable medium of claim 13, wherein the moving entity comprises one or more of: a specific person, a non-specific person, an animal, a moving object, a group of moving persons, animals or objects.

15. The machine-readable medium of claim 13, the operations further comprising:
receiving, using an imaging unit and in conjunction with the radar signal, a camera signal;
preprocessing the camera signal to generate camera metadata, wherein the moving entity and the movement type are determined based on the camera metadata.

16. The machine-readable medium of claim 15, wherein the imaging unit comprises two or more cameras, and wherein the camera metadata comprises depth data.

17. The machine-readable medium of claim 13, the operations further comprising:
receiving, using a microphone and in conjunction with the radar signal, an audio signal;
preprocessing the audio signal to generate audio metadata, wherein the moving entity is determined based on the audio metadata.

18. The machine-readable medium of claim 13, wherein the smart device comprises one or more of: a microphone, a camera, a lamp, a door, a lock, an audio player, a television, and an alarm.

19. The machine-readable medium of claim 13, wherein:
the radar signal comprises one or more chirps, pulses or orthogonal frequency-division multiplexing (OFDM) signals; and
preprocessing the radar signal comprises computing a range, a velocity, or an angle of the moving entity using a fast Fourier transform (FFT).

20. A method comprising:
receiving, using a millimeter-wave multiple antenna array, a radar signal;
preprocessing the radar signal to generate radar metadata;
determining, using a trained machine learning engine and based on at least the radar metadata, a moving entity and a movement type;
identifying, based on at least the determined moving entity and the determined movement type, a smart device and an action for the smart device to take in response to the movement type by the moving entity; and
communicating, to the smart device, a control signal for the identified action.
